(19) United States
(12) Patent Application Publication
(10) Pub. No.: US 2026/0180965 A1
(43) Pub. Date: Jun. 25, 2026

(54) DIGITAL DOCUMENT AUTHENTICATION MANAGEMENT

(71) Applicant: Leo Gabriel L. ARCEO, Las Piñas City (PH)

(72) Inventor: Leo Gabriel L. ARCEO, Las Piñas City (PH)

(21) Appl. No.: 18/711,604

(22) PCT Filed: Nov. 19, 2021
(86) PCT No.: PCT/PH2021/050038

§ 371 Date: May 19, 2024

(51) Int. Cl. H04L 9/40

(52) U.S. Cl. CPC H04L 63/08

(57) ABSTRACT

Various embodiments include network computing devices and methods for managing digital document authentication. A processor of a network computing device may generate a hash value of a digital document, generate a token including the generated hash value, configure the digital document to include the token wherein the presence of the token is obfuscated, and send to a second computing device the digital document comprising the included token. The processor may receive a request to authenticate the digital document including the token, extract the token from the digital document, generate a second hash value of the digital document, and generate a message indicating that the digital document is authenticated in response to determining that the second hash value matches the hash value included in the token.

### BACKGROUND

Digital documents are easily created, copied, modified, and distributed. Because of these conveniences, digital documents face challenges of verification, authentication, and trust. Increasingly, fraudulent digital documents may be used in financial fraud and other cybercrime. A simple, quick, and inexpensive scheme for authenticating digital documents is highly desirable.

### SUMMARY

Various aspects disclosed herein include methods that may be implemented on a processor of a network computing device for managing digital document authentication. Various aspects may include generating a hash value of a digital document, generating a token including the generated hash value, configuring the digital document to include the token wherein the presence of token is obfuscated, and sending to a second computing device the digital document comprising the included token.

In some aspects, configuring the digital document to include the token wherein the digital document may be read without reference to the token may include incorporating the token into a data structure of the digital document such that the digital document may be read without reference to the token. In some aspects, incorporating the token into a data structure of the digital document such that the digital document may be read without reference to the token may include incorporating the token into a data structure of the digital document as a comment.

In some aspects, generating a token including the generated hash value may include generating a token including a digital signature of an entity that approves the digital document. Some aspects may include storing the generated hash value in a digital ledger at a digital ledger address, wherein generating the token including the generated hash value may include generating the token including the digital ledger address.

Some aspects may include receiving a request to authenticate the digital document, wherein the request includes the digital document comprising the included token, extracting the token from the digital document, generating a second hash value of the received digital document, determining whether the second hash value matches the hash value included in the token, and generating a message indicating that the digital document is authenticated in response to determining that the second hash value matches the hash value included in the token. In some aspects, extracting the token from the digital document may include extracting a digital ledger address from the token, and obtaining the hash value of the digital document from a digital ledger at the digital ledger address.

Some aspects may include configuring the token to include additional authentication information. Some aspects may include extracting the additional authentication information from the token, sending the additional authentication information to a second computing device, receiving from the second computing device an indication that the additional authentication information has been authenticated, and generating an indication that the additional authentication information has been authenticated.

Various aspects further include a network computing device having a processor configured with processor executable instructions to perform operations of any of the methods summarized above. Various aspects further include a network processing device for use in a computing device and configured to perform operations of any of the methods summarized above. Various aspects include a network computing device having means for performing functions of any of the methods summarized above. Various aspects include a non-transitory processor-readable storage medium having stored thereon processor-executable instructions configured to cause a processor of a network computing device to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a communication system according to various embodiments.

FIG. 2 is a component block diagram illustrating components of a network element suitable for implementing various embodiments.

FIG. 3 is a process flow diagram illustrating a method for managing digital document authentication according to various embodiments.

FIGS. 4A-4F illustrate process flow diagrams of operations that may be performed as part of the method for managing digital document authentication according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

The term “digital document” is used herein to refer to a digital representation of text or an image, sometimes commonly referred to as a “file” or “document.” Examples of a digital document include representations of text or an image in a digital data structure such as the Portable Document Format (PDF), image formats such as the Portable Network Graphics (PNG), Joint Photographic Experts Group (JPEG or JPG), Tag Image File Format (TIFF), and/or other image formats, as well as audio files in an audio file format, audiovisual files in an audiovisual format, and/or the like.

The term “computing device” is used herein to refer to any one or all of network elements such as servers, routers, set top boxes, head-end devices, and other similar network elements, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, cordless phones, network-connected displays (such as advertisement screens, news screens, and the like), wireless local loop (WLL) station, entertainment devices (for example, a music or video device, or a satellite radio), gaming devices, wireless gaming controllers, cameras, medical devices or equipment, biometric sensors/devices, wearable devices (such as smart watches, smart clothing, smart glasses, smart wrist bands, smart jewelry (for example, smart ring, smart bracelet)), smart meters/sensors, industrial manufacturing equipment, router devices, appliances, global positioning system devices, wireless-network enabled Internet of Things (IoT) devices including large and small machinery and appliances for home or enterprise use, wireless communication elements within autonomous and semiautonomous vehicles, a vehicular component or sensor, wireless devices affixed to or incorporated into various mobile platforms, and similar electronic devices that include a memory, wireless communication components and a programmable processor, or that is configured to communicate via a wireless or wired medium.

The ease with which digital documents may be created, copied, modified, and distributed also make digital documents vulnerable to surreptitious manipulation. Fraud facilitated by manipulated or fraudulent digital documents already accounts for billions of dollars in annual losses. A reliable scheme for authenticating digital documents may facilitate trust in a variety of digital documents. A basic premise of document trust is that an entity releasing a document becomes the authority of that document. Trusted digital documents may be used to facilitate any number of transactions or access to services. For example, an authenticated digital document may be used as an accreditation or certificate issued by a private or governmental organization; an investigative document or report issued by a law enforcement agency or government entity; an official license issued by a government or private entity; bank certifications and statements of account; school or court documents were transcripts; medical records and health test results; digital notarizations of official documents; contracts between private parties; and a variety of other suitable applications.

Various embodiments enable a network computing device to generate a verifiable digital document. In some embodiments, the digital document generated by the network computing device may include information that may be used to verify the digital document, while the presence of such information in the document may be obfuscated such that the presence of such information is not detected by typical file reading software. For example, a PDF document may be accessed and presented (e.g., on a display device such as a phone, tablet, or computer display) by commonly available PDF reader software. In various embodiments, a PDF document may include information that may be used to verify the PDF document, but such information may not be detected or presented by commonly available PDF reader software. However, computing devices may be configured according to various embodiments to generate verifiable digital documents. Computing devices also may be configured to perform authentication operations using information in the generated verifiable digital documents.

In some embodiments, a network computing device may be configured to generate a hash value of a digital document, generate a token including the generated hash value, configure the digital document to include the token in which the presence of the token is obfuscated, and send to a second computing device the digital document including the included token.

In some embodiments, the network computing device may incorporate the token into a data structure of the digital document such that the digital document may be read without reference to the token. In some embodiments, the token may include a digital signature of an entity that approves the digital document. In some embodiments, such entity may include any person or organization originating the digital document. In some embodiments, the network computing device may incorporate the token into a data structure of the digital document as a comment. In some embodiments, the network computing device may append the token to a data structure of the digital document. In some embodiments, the network computing device may concatenate the token with a data structure of the digital document. In some embodiments, the network computing device may incorporate the token into a data structure of the digital document as another aspect of the data structure that is not interpreted by or presented by a typical reader of the particular digital document. In some embodiments, the incorporated token may appear as gibberish or garbage data within or appended to the digital document, or as another form or representation of information that may be ignored, or not read by, a typical reader of the particular digital document.

In some embodiments, the network computing device may store the generated hash value in a digital ledger at a digital ledger address. The network computing device may generate the token including the digital ledger address. In some embodiments, the digital ledger may include any digital ledger or distributed digital ledger, or any other suitable digital ledger data structure, such as a blockchain.

In some embodiments, the network computing device may be configured to perform operations to authenticate the digital document. In some embodiments, the network computing device may receive a request to authenticate the digital document, wherein the request comprises the digital document including the token, extract the token from the digital document, generate a second hash value of the digital document, determine whether the second hash value matches the hash value included in the token, generate a message indicating that the digital document is authenticated in response to determining that the second hash value matches the hash value included in the token. In some embodiments, the network computing device may extract a digital ledger address from the token, and obtain the hash value of the digital document from a digital ledger at the digital ledger address.

In some embodiments, the network computing device may configure the token to include additional information that may be separately authenticated to provide an additional avenue of authenticating the document. For example, information such as a photograph (e.g., of a person signing a document), a driver's license, a digitized physical signature (e.g., a digital representation of a person's hand signature), an image of a fingerprint, retinal pattern, or iris pattern, information representing a person's DNA sequence, video information (e.g., a video of a person signing the document), other biometric information, or any other suitable information may be included in the token. In some embodiments, the network computing device may include or incorporate such additional information into or with the token as part of the process of generating the token.

In some embodiments, the network computing device may be configured to extract or obtain such additional information from the token, and present such information for an authentication independent or separate from determining whether the second hash value matches the hash value included in the token. In some embodiments, the network computing device may present the additional information on or via a computing device display of a second computing device. In some embodiments, the network computing device may send the additional information to the second computing device for presentation by a computing device display of the second computing device. In some embodiments, the second computing device display may present a user interface configured to receive an input indicating whether the additional information that is presented is verified. For example, the additional information may include a photograph or video, and the network computing device may send the photograph or video to the second computing device for display. As another example, the additional information may include a representation of a fingerprint, and the network computing device may send the representation of the fingerprint to the second computing device for presentation (e.g., display). Other examples are also possible. The second computing device may be configured to receive an input (e.g., from a user) indicating that the presented additional information is authenticated. For example, the received input may indicate that a user recognizes a person in a displayed photograph or video. As another example, the received input may indicate that the user has been able to verify the fingerprint.

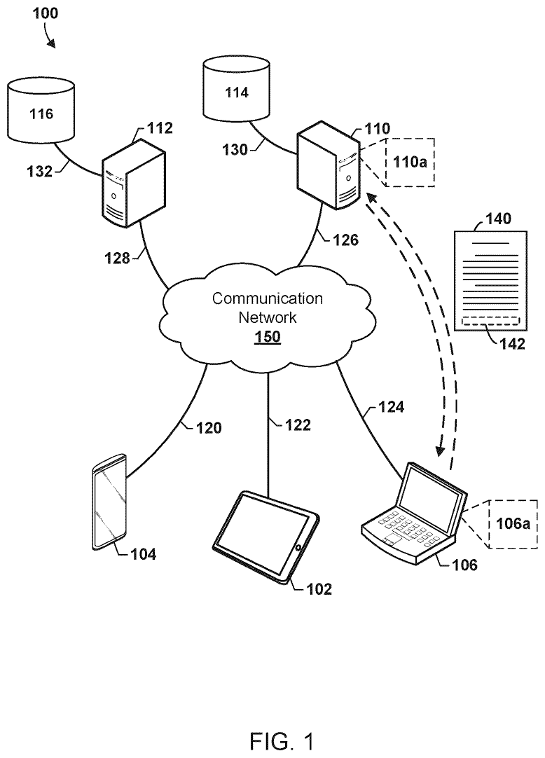

Various embodiments may be implemented within a variety of communication systems 100, an example of which is illustrated in FIG. 1. With reference to FIG. 1, the communication system 100 may include various user equipment (UE) such as a tablet computing device 102, a mobile device 104, a computer 106, or another suitable computing platform, regardless of form factor. In addition, the communication system 100 may include network elements, such as a network computing devices 110 and 112, and a communication network 150. The tablet computing device 102, the mobile device 104, the computer 106, and the network computing devices 110 and 112 may communicate with the communication network 150 via a respective wired or wireless communication link 120, 122, 124, 126, 128, 130, and 132. The computing device 110 may communicate with a data store 114 via a wired or wireless communication link 130. The computing device 112 may communicate with a data store 116 via a wired or wireless communication link 132.

The tablet computing device 102 may include any of a variety of portable computing devices of a generally large, handheld form factor. The mobile device 104 may include any of a variety of portable computing platforms and communication platforms, such as cell phones, smart phones, Internet access devices, and the like. The computer 106 may include any of a variety of personal computers, desktop computers, laptop computers, and the like.

The computing device 110 may be configured to perform operations related to managing digital document authentication. In some embodiments, execution of a related computing task, operation, or service may require data or information stored in the data store 114.

The network computing device 110 may be configured (e.g., via computer-readable instructions such as client software 110a) to perform operations related to digital document authentication. In some embodiments, the network computing device 110 may be configured to generate a hash value of the digital document 140, generate a token 142 that may include the generated hash value, and configure the digital document 140 to include the token 142. The network computing device 110 may be configured to send the digital document 140 including the token 142 to one or more of the computing devices 102-106. Various operations that may be performed by the network computing device 110 are further described below.

The tablet computing device 102, the mobile device 104, and the computer 106 may each include a processor or processing device that may execute one or more client applications (e.g., client application 106a). The client application 106a may be configured to send a digital document 140 to the network computing device 110, and to receive the digital document and/or information related to the digital document 140 from the network computing device 110. The computer 106 may send the digital document 140 including the token 142 to another computing device, such as the tablet computing device 102 and/or the mobile device 104.

In some embodiments, the network computing device 112 may be configured to perform operations related to digital ledgers and or distributed digital ledgers. In some embodiments, the network computing device 112 may be configured to manage a digital ledger in which a generated hash value (e.g., related to the digital document 140) may be stored (e.g., in the data store 116). In some embodiments, the network computing device 112 may be configured to receive requests for information from the digital ledger and/or process such requests.

The communication network 150 may support wired and/or wireless communication among the tablet computing device 102, the mobile device 104, the computer 106, and the computing devices 110 and 112. The communication network 150 may include one or more additional network elements, such as servers and other similar devices (not illustrated). The communication system 100 may include additional network elements to facilitate communication among the tablet computing device 102, the mobile device 104, the computer 106, and the computing devices 110 and 112. The communication links 120, 122, 124, 126, 128, 130, and 132 may include wired and/or wireless communication links. Wired communication links may include coaxial cable, optical fiber, and other similar communication links, including combinations thereof (for example, in an HFC network). Wireless communication links may include a plurality of carrier signals, frequencies, or frequency bands, each of which may include a plurality of logical channels. Wired communication protocols may use a variety of wired networks (e.g., Ethernet, TV cable, telephony, fiber optic and other forms of physical network connections) that may use one or more wired communication protocols, such as Data Over Cable Service Interface Specification (DOCSIS), Ethernet, Point-To-Point protocol, High-Level Data Link Control (HDLC), Advanced Data Communication Control Protocol (ADCCP), and Transmission Control Protocol/Internet Protocol (TCP/IP), or another suitable wired communication protocol.

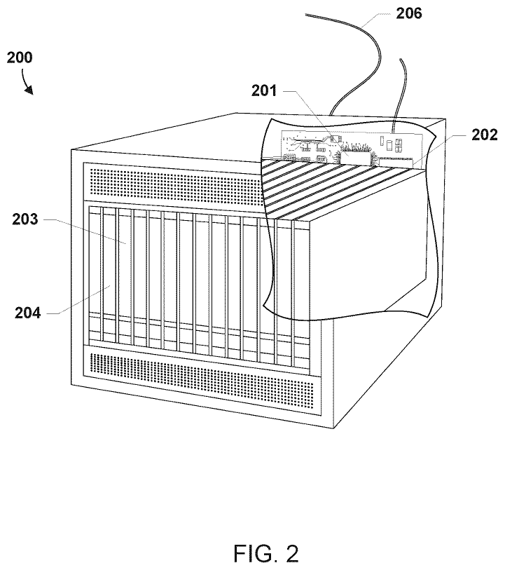

The wireless and/or wired communication links 120, 122, 124, 126, 128, 130, and 132 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication links 120, 122, 124, 126, 128, 130, and 132 include an Institute of Electrical and Electronics Engineers (IEEE) 802.15.4 protocol (such as Thread, ZigBee, and Z-Wave), any of the Institute of Electrical and Electronics Engineers (IEEE) 16.11 standards, or any of the IEEE 802.11 standards, the Bluetooth standard, Bluetooth Low Energy (BLE), 6LoWPAN, LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. Further examples of RATs that may be used in one or more of the various wireless communication links within the communication system 100 include 3GPP Long Term Evolution (LTE), 3G, 4G, 5G, Global System for Mobility (GSM), GSM/General Packet Radio Service (GPRS), Enhanced Data GSM Environment (EDGE), Code Division Multiple Access (CDMA), frequency division multiple access (FDMA), time division multiple access (TDMA), Wideband Code Division Multiple Access (W-CDMA), Worldwide Interoperability for Microwave Access (WiMAX), Time Division Multiple Access (TDMA), and other mobile telephony communication technologies cellular RATs, Terrestrial Trunked Radio (TETRA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, and other mobile telephony communication technologies cellular RATs or other signals that are used to communicate within a wireless, cellular or Internet of Things (IoT) network or Various embodiments may use a computing device as a server, router, or another suitable element of a communication network. Such network elements may typically include at least the components illustrated in FIG. 2, which illustrates an example network computing device 200. With reference to FIGS. 1 and 2, the network computing device 200 (e.g., the network computing devices 110 and 112) may include a processor 201 coupled to volatile memory 202 and a large capacity nonvolatile memory, such as a disk drive 203. The network computing device 200 may also include a peripheral memory access device such as a floppy disc drive, compact disc (CD) or digital video disc (DVD) drive 204 coupled to the processor 201. The network computing device 200 may also include network access ports 206 (or interfaces) coupled to the processor 201 for establishing data connections with a network, such as the Internet and/or a local area network coupled to other system computers and servers. Similarly, the network computing device 200 may include additional access ports, such as USB, Firewire, Thunderbolt, and the like for coupling to peripherals, external memory, or other devices.

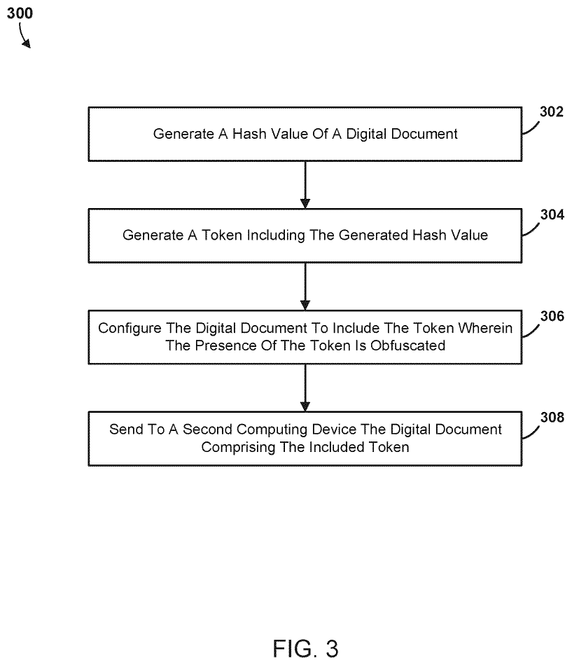

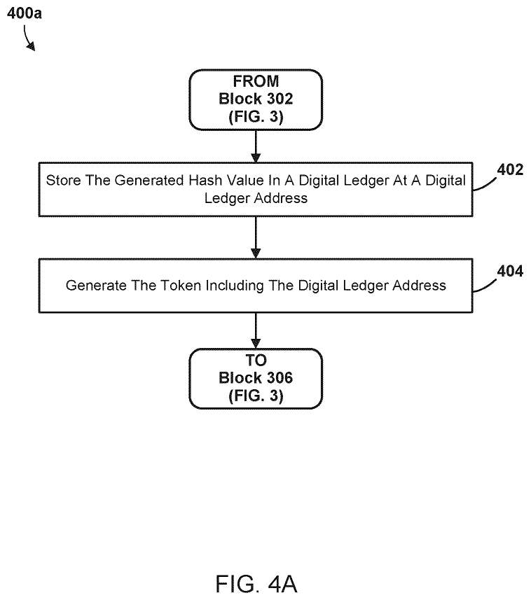

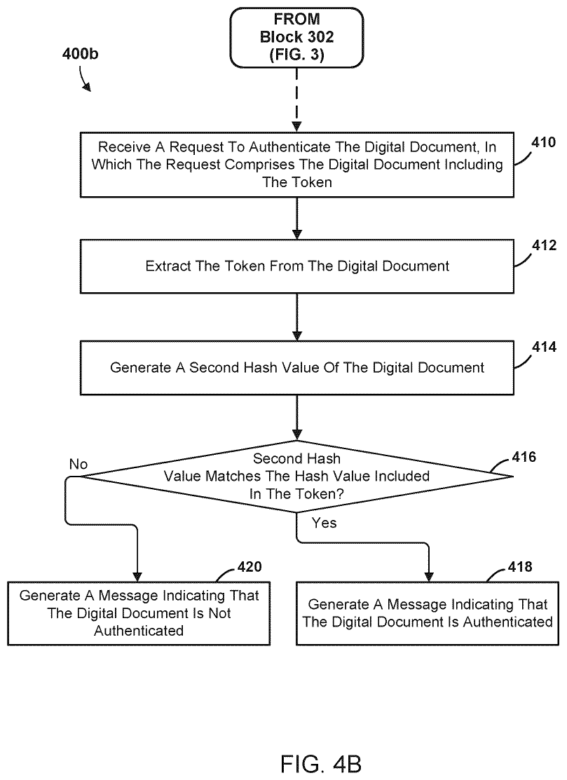

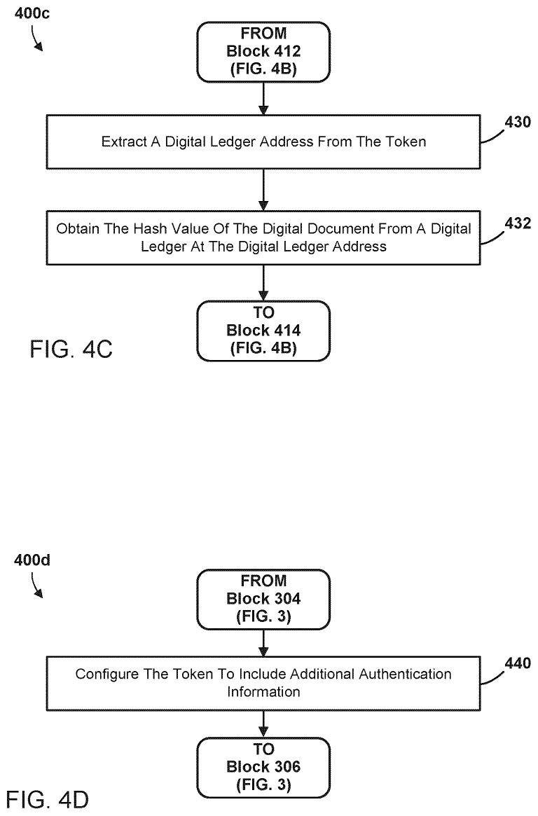

FIG. 3 is a process flow diagram illustrating a method 300 for managing digital document authentication according to various embodiments. With reference to FIGS. 1-3, the operations of the method 300 may be implemented in hardware components and/or software components of a network computing device (e.g., the network computing device 110, 112, 200) the operation of which may be controlled by one or more processors (e.g., the processor 201 and/or the like), referred to herein as a “processor”.

In block 302, the processor may generate a hash value of a digital document (e.g., a previously-created digital document). For example, having received a digital document (e.g., 140) from a computing device (e.g., 102, 104, 106), the processor may generate a hash value of the digital document.

In block 304, the processor may generate a token including the generated hash value. In various embodiments, the token may include a data structure configured to include the generated hash value. In some embodiments, the data structure of the token may reflect, or be compatible with, a data structure of the digital document.

In block 306, the processor may configure the digital document to include the token. In various embodiments, the processor may configure the digital document in a manner that the presence of the token is obfuscated. In some embodiments, the processor may incorporate the token into a data structure of the digital document such that the digital document may be read without reference to the token. In some embodiments, the processor may incorporate the token into a data structure of the digital document as a comment. In some embodiments, the processor may generate the token that includes a digital signature of an entity that approves the digital document.

In block 308, the processor may send to a second computing device the digital document including the token.

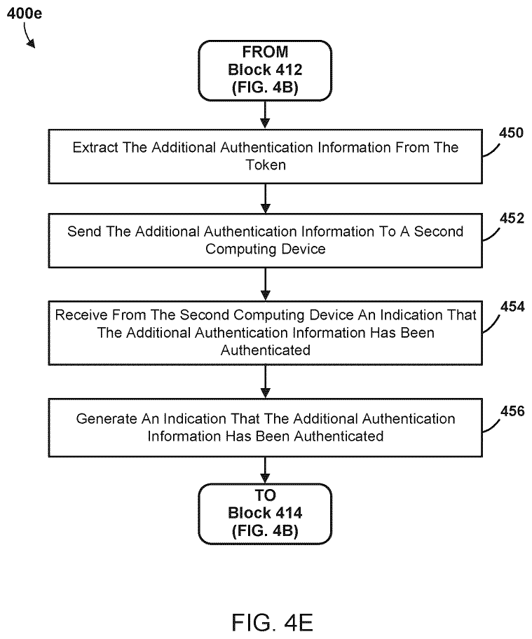

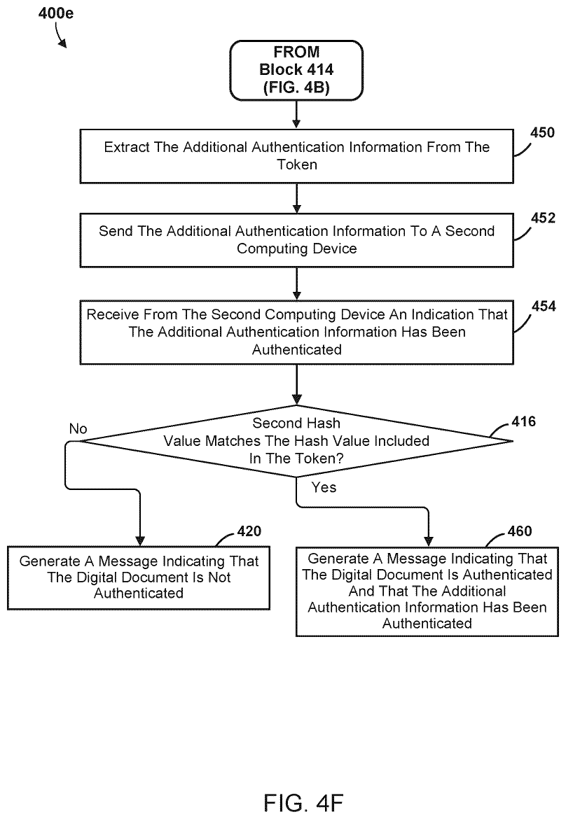

FIGS. 4A-4F, illustrate process flow diagrams of operations 400a-400f that may be performed as part of the method 300 for managing digital document authentication according to various embodiments. With reference to FIGS. 4A-4F, the operations 400a-400f may be implemented in hardware components and/or software components of a network computing device (e.g., the network computing device 110, 112, 200) the operation of which may be controlled by one or more processors (e.g., the processor 201 and/or the like).

Referring to FIG. 4A, following the performance of the operations of block 302 (FIG. 3), the processor may store the generated hash value in a digital ledger at a digital ledger address in block 402. For example, the processor may store the generated hash value in a digital ledger via the network computing device 112 at an address in the digital ledger. The digital ledger address may enable a computing device to access the stored hash value in the digital ledger more quickly and efficiently than by searching the digital ledger for the stored hash value.

In block 404, the processor may generate the token including the digital ledger address.

The processor may proceed to perform the operations of block 306 (FIG. 3) as described.

Referring to FIG. 4B, at a time after the performance of the operations of block 302 (FIG. 3), the processor may receive a request to authenticate the digital document in block 410. The request may include the digital document (e.g., 140), and the digital document may include the token (e.g., 142). In some embodiments, the network computing device 110 may receive a request to authenticate a digital document from any of the computing devices 102-106.

In block 412, the processor may extract the token from the digital document.

In block 414, the processor may generate a second hash value of the digital document.

In determination block 416, the processor may determine whether the second hash value matches the hash value included in the token.

In response to determining that the second hash value matches the hash value included in the token (i.e., determination block 416 =“Yes”), the processor may generate a message indicating that the digital document is authenticated in block 418. In some embodiments, generating the message indicating that the digital document is authenticated may include sending the indication to the computing device that requested authentication of the digital document.

In response to determining that the second hash value does not match the hash value included in the token (i.e., determination block 416 =“No”), the processor may generate a message indicating that the digital document is not authenticated in block 420. In some embodiments, generating the message indicating that the digital document is not authenticated may include sending the indication to the computing device that requested authentication of the digital document.

Referring to FIG. 4C, in some embodiments, following the performance of the operations of block 412 (FIG. 4B), the processor may extract a digital ledger address from the token in block 430.

In block 432, the processor may obtain the hash value of the digital document from a digital ledger at the digital ledger address. In some embodiments, the processor may send a request to a network computing device (e.g., 112) for information stored at the digital ledger address in the digital ledger. In response to such request, the processor may receive from the network computing device the hash value of the digital document.

The processor may proceed to perform the operations of block 414 (FIG. 4B) as described.

Referring to FIG. 4D, in some embodiments, following the performance of the operations of block 304 (FIG. 3), the processor may configure the token to include additional authentication information. In some embodiments, the additional information may include information such as a photograph (e.g., of a person signing a document), a driver's license, a digitized physical signature (e.g., a digital representation of a person's hand signature), an image of a fingerprint, retinal pattern, or iris pattern, information representing a person's DNA sequence, video information (e.g., a video of a person signing the document), or any other suitable information may be included in the token.

The processor may proceed to perform the operations of block 406 (FIG. 3) as described.

Referring to FIG. 4E, in some embodiments, following the performance of the operations of block 412 (FIG. 4B), the processor may extract the additional information from the token in block 450.

In block 452, the processor may send the additional authentication information to a second computing device. In some embodiments, the second computing device may include the computing device that has requested that the processor authenticate the digital document. In some embodiments, the second computing device may include another computing device and/or network computing device.

In block 454, the processor may receive from the second computing device an indication that the additional authentication information has been authenticated.

In block 456, the processor may generate an indication that the additional authentication information has been authenticated.

Referring to FIG. 4F, in some embodiments, the processor may factor the indication that the additional authentication information has been authenticated that is received from the second computing device into a determination that the digital document is authenticated.

For example, the processor may receive from the second computing device an indication that the additional authentication information has been authenticated in block 454 as described. The processor may then determine whether the second hash value matches the hash value included in the token in determination block 416 as described.

In some embodiments, in response to determining that the second hash value matches the hash value included in the token (i.e., determination block 416=“Yes”), the processor may generate a message indicating that the digital document is authenticated and that the additional authentication information has been authenticated in block 460. In some embodiments, the processor may generate a single indication that the digital document is authenticated that is based on both the indication from the second computing device that the additional authentication information has been authenticated and the determination that the second hash value matches the hash value included in the token.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations methods and operations 300 and 400a-400f may be substituted for or combined with one or more operations of the methods 300 and 400a-400f and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1. A network computing device, comprising:
a processor configured with processor-executable instructions to:
generate a hash value of a digital document;
generate a token including the generated hash value;
configure the digital document to include the token wherein the presence of the token is obfuscated; and
send to a second computing device the digital document comprising the included token.

2. The network computing device of claim 1, wherein the processor is further configured with processor-executable instructions to incorporate the token into a data structure of the digital document such that the digital document may be read without reference to the token.

3. The network computing device of claim 2, wherein the processor is further configured with processor-executable instructions to incorporate the token into a data structure of the digital document as a comment.

4. The network computing device of claim 1, wherein the processor is further configured with processor-executable instructions to generate a token including a digital signature of an entity that approves the digital document.

5. The network computing device of claim 1, wherein the processor is further configured to:
store the generated hash value in a digital ledger at a digital ledger address; and
generate the token including the digital ledger address.

6. The network computing device of claim 1, wherein the processor is further configured to:
receive a request to authenticate the digital document, wherein the request comprises the digital document including the token;
extract the token from the digital document;
generate a second hash value of the digital document;
determine whether the second hash value matches the hash value included in the token; and
generate a message indicating that the digital document is authenticated in response to determining that the second hash value matches the hash value included in the token.

7. The network computing device of claim 6, wherein the processor is further configured to:
extract a digital ledger address from the token; and
obtain the hash value of the digital document from a digital ledger at the digital ledger address.

8. The network computing device of claim 6, wherein the processor is further configured to configure the token to include additional authentication information.

9. The network computing device of claim 8, wherein the processor is further configured to:
extract the additional authentication information from the token;
send the additional authentication information to a second computing device;
receive from the second computing device an indication that the additional authentication information has been authenticated; and
generate an indication that the additional authentication information has been authenticated.

10. A method performed by a processor of a network computing device for managing digital document authentication, comprising:
generating a hash value of a digital document;
generating a token including the generated hash value;
configuring the digital document to include the token wherein the presence of token is obfuscated; and
sending to a second computing device the digital document comprising the included token.

11. The method of claim 10, wherein configuring the digital document to include the token wherein the digital document may be read without reference to the token comprises incorporating the token into a data structure of the digital document such that the digital document may be read without reference to the token.

12. The method of claim 11, wherein incorporating the token into a data structure of the digital document such that the digital document may be read without reference to the token comprises incorporating the token into a data structure of the digital document as a comment.

13. The method of claim 10, wherein generating a token including the generated hash value comprises generating a token including a digital signature of an entity that approves the digital document.

14. The method of claim 10, further comprising:
storing the generated hash value in a digital ledger at a digital ledger address;
wherein generating the token including the generated hash value comprises generating the token including the digital ledger address.

15. The method of claim 10, further comprising:
receiving a request to authenticate the digital document, wherein the request includes the digital document comprising the included token;
extracting the token from the digital document;
generating a second hash value of the received digital document;
determining whether the second hash value matches the hash value included in the token; and
generating a message indicating that the digital document is authenticated in response to determining that the second hash value matches the hash value included in the token.

16. The method of claim 15, wherein extracting the token from the digital document comprises:
extracting a digital ledger address from the token; and
obtaining the hash value of the digital document from a digital ledger at the digital ledger address.

17. The method of claim 15, further comprising configuring the token to include additional authentication information.

18. The method of claim 16, further comprising:
extracting the additional authentication information from the token;
sending the additional authentication information to a second computing device;
receiving from the second computing device an indication that the additional authentication information has been authenticated; and
generating an indication that the additional authentication information has been authenticated.

19. A non-transitory processor-readable medium having stored thereon processor-executable instruction configured to cause a processing device in a network computing device to perform operations comprising:
generating a hash value of a digital document;
generating a token including the generated hash value;
configuring the digital document to include the token wherein the presence of token is obfuscated; and
sending to a second computing device the digital document comprising the included token.

20. The non-transitory processor-readable medium of claim 19, wherein the stored processor-executable instructions are configured to cause a processor of a wireless device to perform operations such that configuring the digital document to include the token wherein the digital document may be read without reference to the token comprises incorporating the token into a data structure of the digital document such that the digital document may be read without reference to the token.

21. The non-transitory processor-readable medium of claim 20, wherein the stored processor-executable instructions are configured to cause a processor of a wireless device to perform operations such that incorporating the token into a data structure of the digital document such that the digital document may be read without reference to the token comprises incorporating the token into a data structure of the digital document as a comment.

22. The non-transitory processor-readable medium of claim 19, wherein the stored processor-executable instructions are configured to cause a processor of a wireless device to perform operations such that generating a token including the generated hash value comprises generating a token including a digital signature of an entity that approves the digital document.

23. The non-transitory processor-readable medium of claim 19, wherein the stored processor-executable instructions are configured to cause a processor of a wireless device to perform operations further comprising:
storing the generated hash value in a digital ledger at a digital ledger address;
wherein generating the token including the generated hash value comprises generating the token including the digital ledger address.

24. The non-transitory processor-readable medium of claim 19, wherein the stored processor-executable instructions are configured to cause a processor of a wireless device to perform operations further comprising:
receiving a request to authenticate the digital document, wherein the request includes the digital document comprising the included token;
extracting the token from the digital document;
generating a second hash value of the received digital document;
determining whether the second hash value matches the hash value included in the token; and
generating a message indicating that the digital document is authenticated in response to determining that the second hash value matches the hash value included in the token.

25. The non-transitory processor-readable medium of claim 24, wherein the stored processor-executable instructions are configured to cause a processor of a wireless device to perform operations such that extracting the token from the digital document comprises:
extracting a digital ledger address from the token; and
obtaining the hash value of the digital document from a digital ledger at the digital ledger address.

26. The non-transitory processor-readable medium of claim 24, wherein the stored processor-executable instructions are configured to cause a processor of a wireless device to perform operations further comprising configuring the token to include additional authentication information.

27. The non-transitory processor-readable medium of claim 26, wherein the stored processor-executable instructions are configured to cause a processor of a wireless device to perform operations further comprising:
extracting the additional authentication information from the token;
sending the additional authentication information to a second computing device;
receiving from the second computing device an indication that the additional authentication information has been authenticated; and
generating an indication that the additional authentication information has been authenticated.

28. (canceled)
